(19) United States
(12) Patent Application Publication
(10) Pub. No.: US 2009/0232134 A1
(43) Pub. Date: Sep. 17, 2009

(54) INDIRECT ADDRESS CONNECTION SERVICE OVER AN EXTENDED NETWORK

(76) Inventor: Thierry Lamouline, Tassin (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 12/140,908

(22) Filed: Jun. 17, 2008

(30) Foreign Application Priority Data
Mar. 14, 2008 (FR) 0801417
May 22, 2008 (FR) 0802782

(51) Int. Cl. H04L 12/56

(52) U.S. Cl. 370/389

(57) ABSTRACT

Indirect network address server, comprising a store (144) of correlations between address calls and network addresses, an address providing service (142) designed to respond to the submission of an address call by giving back the network address corresponding to it, and a user accounts manager (112),

the storage (144) of correlations between address calls and network addresses comprising address calls stored as multiplets of a predetermined format, this format comprising an element linked to a user provided with an account according to a predetermined naming rule, whilst the network addresses are indirect addresses, the address providing service (142) being designed to respond to an address call in the form of a multiplet having the predetermined format by giving back the indirect network address that corresponds to this multiplet, subject to a first condition being met, which associates the link with a user according to said predetermined naming rule.

The invention relates to the field of information technology over extended networks.

Current information technology terminals or stations have a considerable internal data storage capacity, typically around a hundred gigabytes or more. It is already difficult to navigate, even with a well-selected structure of directories. When it is connected to an extended network such as the Internet such a station potentially has access to a virtually limitless amount of information, for which organisation is an impossibility.

Various solutions are used to attempt to make life easier for the user. However, they are not entirely satisfactory.

The present invention sets out to remedy the situation.

It proposes first of all a network address server which comprises a store of correlations between address calls and network addresses, and an address providing service designed to respond to the submission of an address call by giving back the network address corresponding to it.

According to one aspect of the invention, the network address server comprises a user account manager. The storage of correlations between address calls and network addresses comprises address calls stored as multiplets of a predetermined format, this format comprising an element linked to a user according to a predetermined naming rule. For their part, the network addresses are indirect network addresses (domain name or, more generally, URL). In addition, the address providing service is designed to respond to an address call in the form of a multiplet having the predetermined format by restoring the indirect network address corresponding to this multiplet, subject to a first condition being met, which associates the link with a user according to said predetermined naming rule.

According to another aspect of the invention, a user data processing station is proposed comprising a browser and further comprising a mechanism capable of establishing a connection with an indirect network address server as defined above. The connection may include a parameter that comprises an address call in the form of a multiplet of a predetermined format. On confirmed return, the mechanism activates the browser with at least some of the return data as network address. For example, the return data may comprise a number of network addresses, one of which will be chosen by the user.

According to other aspects of the invention the latter is in the form of a process.

In one of the embodiments, a process for assisting data navigation is proposed in particular, in which a server is provided that has a store of correlations between address calls and network addresses, and an address providing service, designed to respond to the presenting of an address call by giving back a network address corresponding thereto. Also, this server is interrogated in order to reach a network location.

This process is notable in that it comprises the following steps:
a. maintaining a user account manager on the server,
b. storing, on the server, correlations between address calls and indirect network addresses, comprising address calls stored as multiplets of a predetermined format, this format comprising an element linked to a user according to a predetermined naming rule,
c. designing the address providing service to respond to an address call in the form of a multiplet having the predetermined format by giving the indirect network address corresponding to this multiplet, subject to a first condition being met, which associates the link with a user according to said predetermined naming rule, and
d. providing at least one user station with a mechanism capable of establishing a connection with said server, the connection allowing an address call in the form of a multiplet of a predetermined format, and, once return has been confirmed, activating the browser with at least some of the return data as an indirect network address.

Further features and advantages of the invention will become apparent from the description that follows and the attached drawings, wherein:

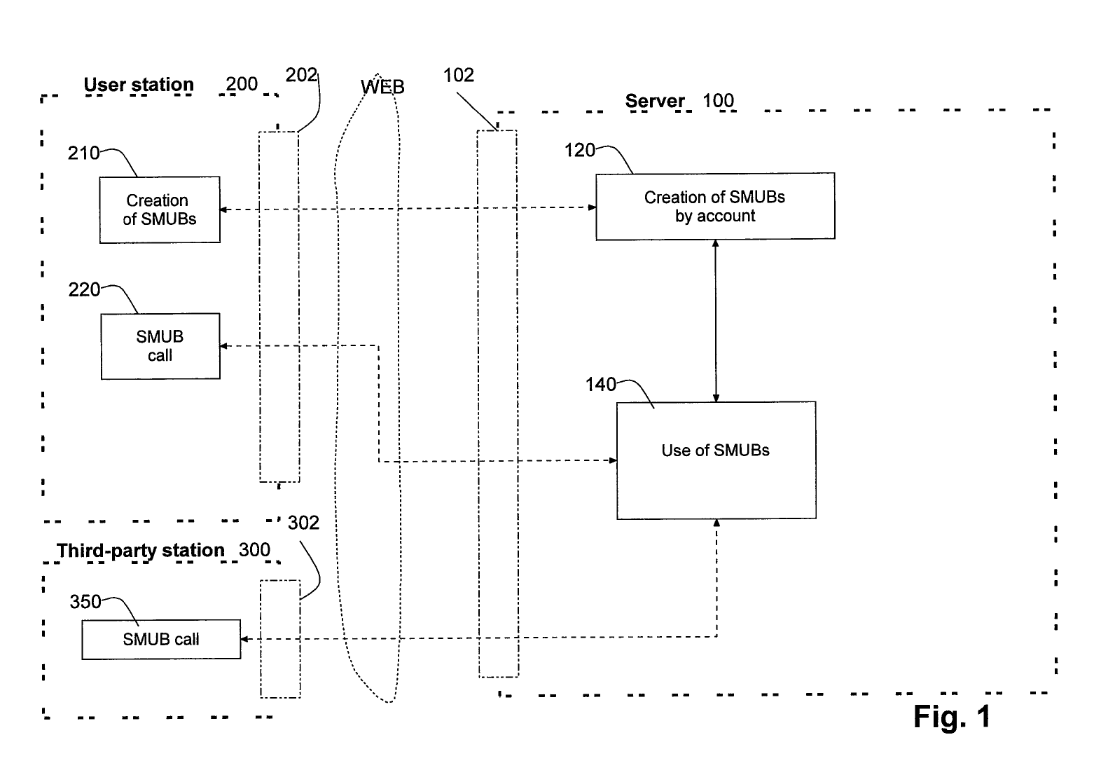

FIG. 1 is a block diagram of the basic IT structure to which the invention may be applied,

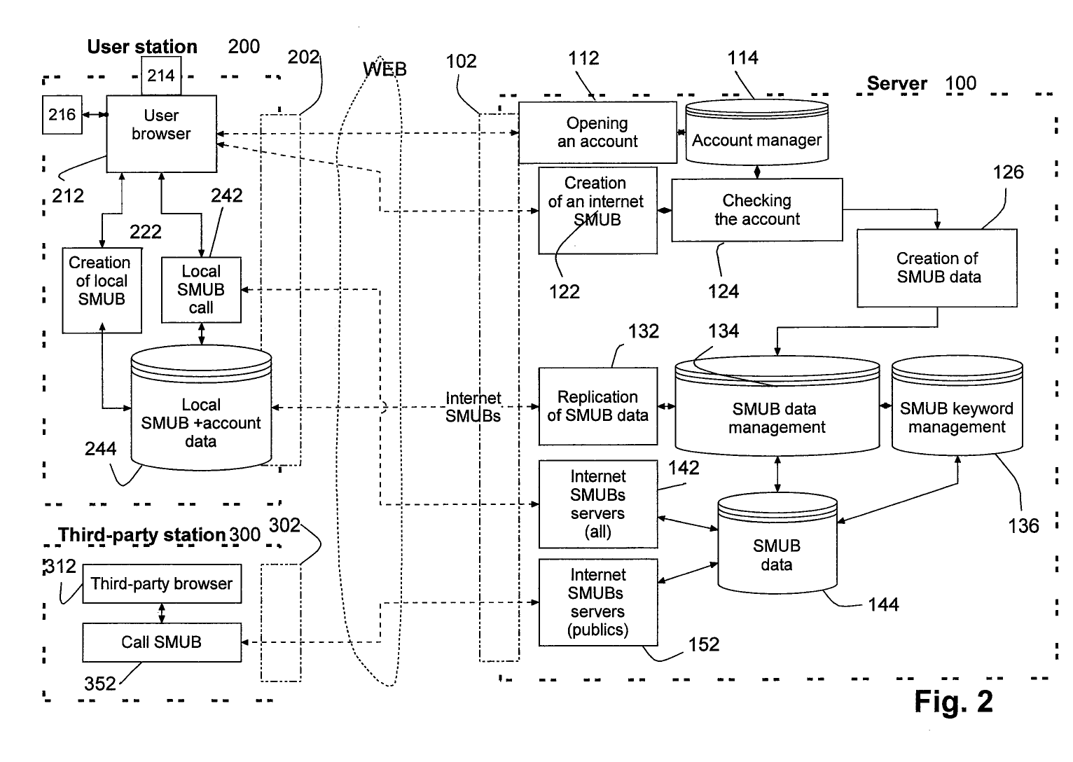

FIG. 2 is a detailed block diagram of one embodiment of the invention,

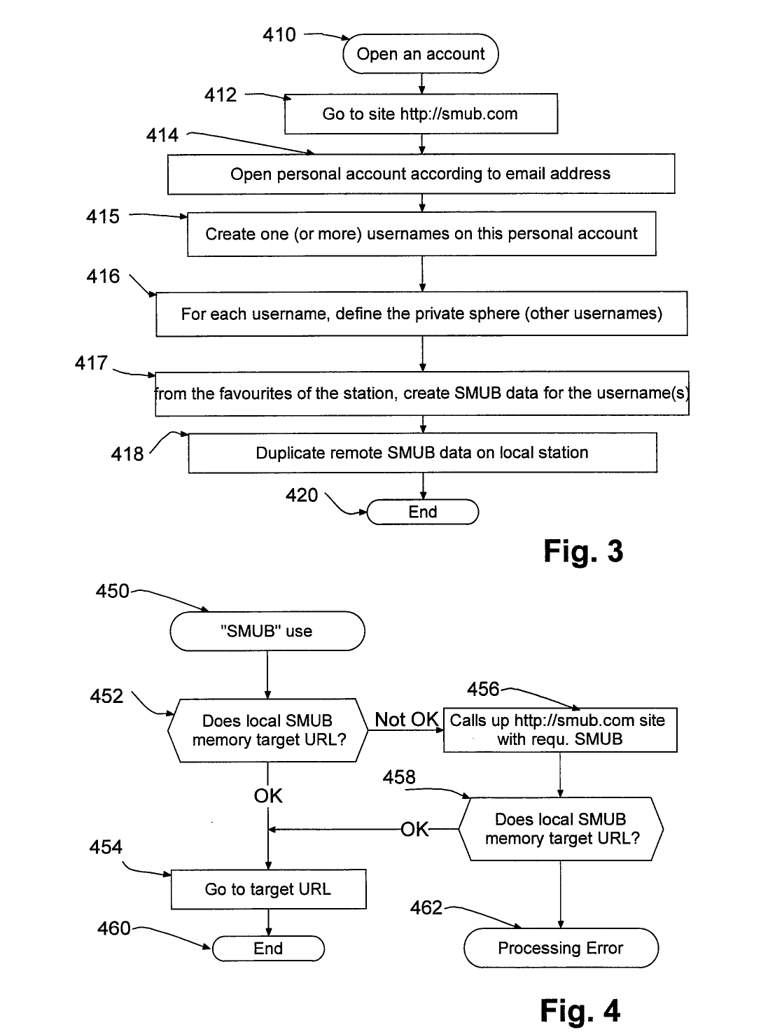

FIG. 3 is a flow diagram generally showing the setting up of accounts and addressing data stored in a server according to FIG. 2,

FIG. 4 is a flow diagram generally showing the use of the addressing data stored in a user post according to FIG. 2,

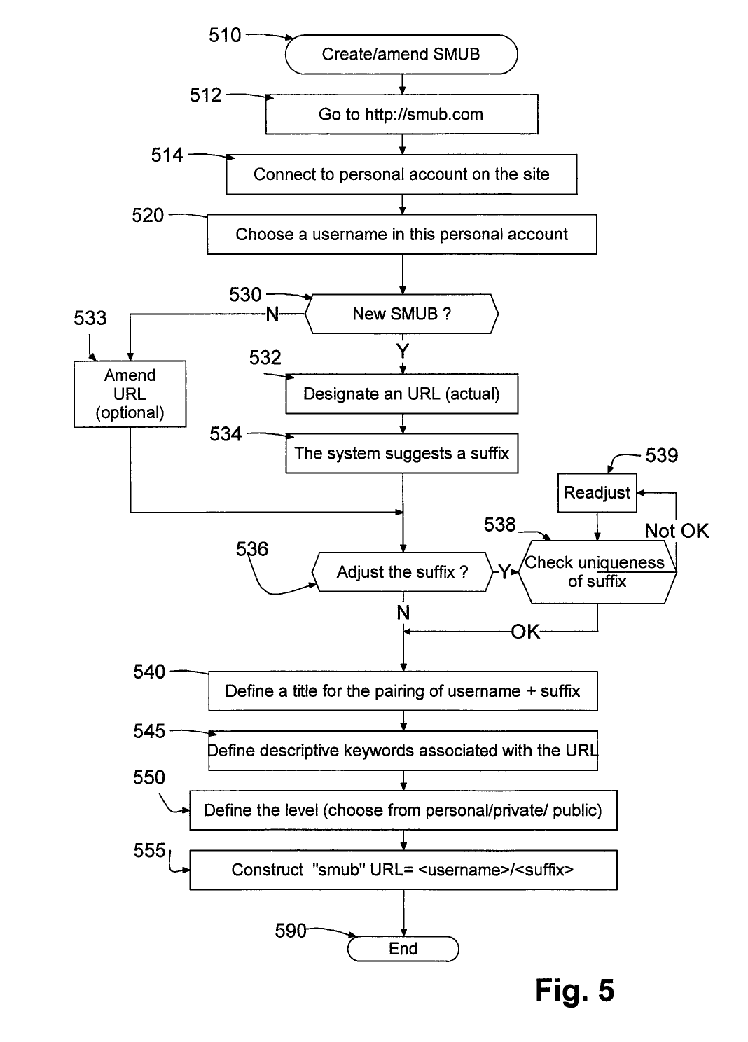

FIG. 5 is a flow diagram showing the setting up and amending of addressing data in more detail,

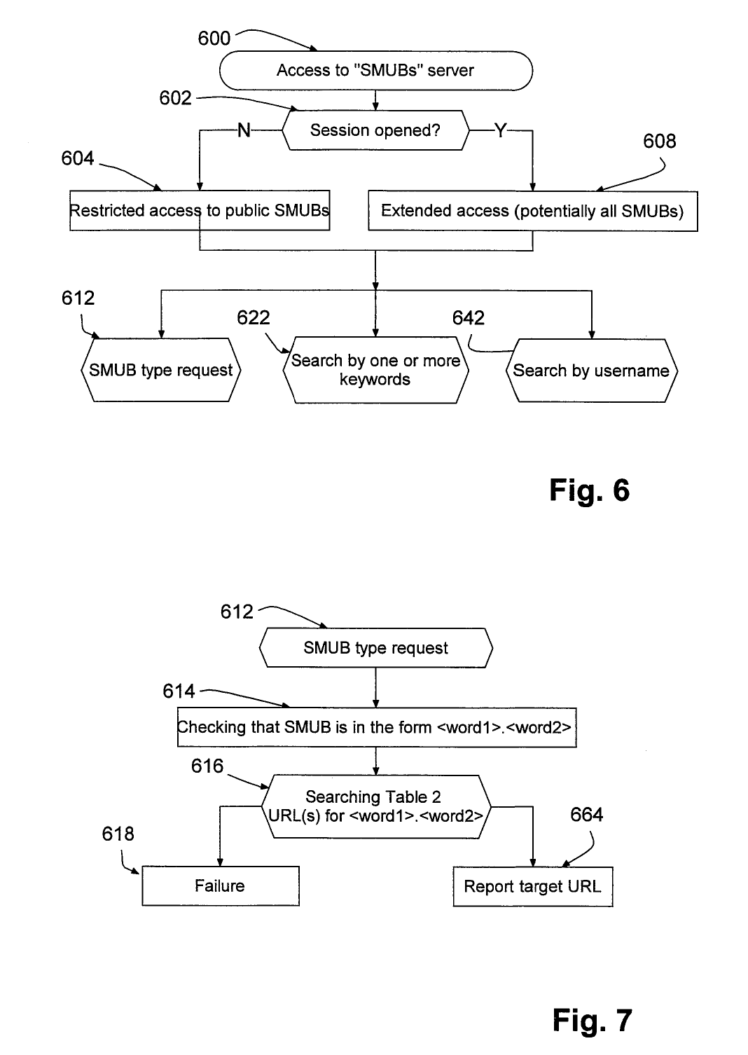

FIG. 6 is a diagram showing the presentation to the user of different types of access to the addressing data, and

FIGS. 7 to 9 are flow diagrams illustrating these different forms of call-up of the addressing data.

The drawings and description that follow essentially contain elements of a definite nature. They may not only help to assist with the understanding of the present invention but may also contribute to its definition, in some cases.

Moreover, the detailed description is supplemented by the following annexes:
Annexe A contains tables that define an example of data structures according to the present invention.

These Annexes are kept separate with a view to clarification and to assist with looking up. They form an integral part of the description and can therefore serve not only to assist with the understanding of the present invention but may also contribute to its definition, in some cases. This also applies to the drawings, in every respect.

Reference will now be made to FIG. 1, which describes the general structure of a system to which the apparatus and process according to the present invention could apply.

In the present description, the acronym SMUB (short for Smart Multi-Usage Bookmark) denotes a string of characters obeying a selected predetermined format which is of the <word1>/<word2> type in the preferred embodiment.

It is known that in an extended network such as the Internet, there are physical addresses, or IP addresses, which appear meaningless and are therefore rarely used directly. It is preferred to use the URL (“Uniform Resource Locator”), which can be seen as an indirect address which make it possible to find the physical address through which a domain name server (DNS) is called up. Similarly, in an IT station, the direct address of a disk or other memory support is rarely used, if at all; rather, directories are used which are also a form of indirect addressing. The same is even more true in a local network. The present application relates to this type of indirect addressing which, although more meaningful than the direct addresses, also very quickly becomes impenetrable and/or difficult to manage.

The available tools include the “favourites” or “shortcuts”. They are simple to use. However, the problem then shifts to the management and organisation of the shortcuts. Moreover, a nomadic IT user will have to copy his shortcuts to all the different terminals that he uses. The use of “favourites” or “shortcuts” is therefore not truly satisfactory.

Hence the success of search engines, the recent versions of which operate equally within the local station and on the extended network. They also have their drawbacks. First, the integral indexing of the data stored on the local station uses up considerable resources, both for storage and in processing capacity. Moreover, once the location of the data being sought has been found, a shortcut or favourite has to be used if one wishes to avoid having to run the same search again next time. The organisational disadvantages of shortcuts are then encountered once more, as well as their local nature. WO2008/006999 proposes means for organising indexation as a function of the contents of documents. However, this is not entirely satisfactory either in every case.

Different proposals for ameliorating the situation will be described below.

The term “indirect address over the extended network” or, more briefly, “indirect address” as used hereinafter is primarily taken to mean a URL-type address. However, the invention may also apply to an address in an IT station or in a local network accessible to an IT station.

On the right of FIG. 1, a server station 100 consists of a web interface 102, which allows the exchange of data over an extended network (web) with a module for creating SMUBs by account (designated 120) and a module for using SMUBs designated 140.

At a user station 200 there is also a web interface 202, which allows the SMUB creating module at the user end, designated 210, to interact via the extended network with the module 120 of the server 100. Similarly, a module for calling up SMUBs 220 can interact with the module 140 of the server 100. Finally, it is possible to provide a third station 300, also provided with a network interface 302, which enables a module for calling up SMUBs 350 to cooperate with the module 140 of the server 100. It will be seen that this cooperation is slightly different from that of the call-up module 220 of a user station.

The same structure is found in FIG. 2, but in a more detailed form, corresponding to a particular embodiment of the invention.

The creation module 120 of FIG. 1 may be regarded as comprising modules 112 to 126 of FIG. 2.

The module 140 of FIG. 1 may be regarded as including the modules 142 and 152 of FIG. 2.

Turning now to the user station 200, FIG. 2 shows a browser 212, or other communication function, capable of cooperating with the module 112 of the server, to carry out the creation of an account, the management data of which are in a memory 114.

This account creation may be carried out in the conventional manner, adapted as described below.

The browser may also interact with an SMUB creating function known as “internet”, as opposed to the creation of a “local” SMUB which is the function 222 of the user station.

The function 122 of the server 100 will first of all interact with a function of checking the existence of an account to the benefit of the user requesting its creation. This function is designated 124. It is only once this check has been carried out that the creation of actual SMUB data can proceed, in the unit 126.

The SMUB data are stored in a memory 134, which cooperates with the optional management of the keywords 136.

Returning now to the user station 200, it is also possible to create local SMUBs therein, by a creation function 222 which is similar to the function 126 of the server but is confined to designating locations or directories situated within the user station.

These local data are stored in the memory 244 and may be the subject of a local SMUB call at 242.

When a user station has created internet SMUB data, it can replicate them by means of the function 132 in the local data memory 244. This avoids calling up the server to obtain the functions in question.

The data thus replicated at the user station 200 are those which belong to one or more accounts assigned to the user stations 200.

The user station 200 may also seek to access other SMUBs created by other user stations. The browser 212 may have its own interface, for example a window having a plurality of fields, e.g. two, for words corresponding to a format of the SMUB. The browser 212 may also have a lookup function 214 for using a field, for example a URL field, of an application, such as a web browser, for example in the form word1/word2. The lookup function 214 referred to as “smubit” by way of example sends the variables word1 and word2 to the actual browser 212 in which the processing described below may be carried out. The lookup function 214 interacts with another application, for example the web interface 202 or the actual browser 212 for sampling the variables of the SMUB.

The user station 200 may have a voice command 216, for example comprising a microphone and recognition software such as “Dragon Naturally Speaking”®. The voice command 216 may control the filling of windows to provide information as to the variables of the SMUB, and their validation. In this case, the caller module 242, after having checked that it is not a local SMUB, will interrogate the use at the internet SMUB server 142. As this is a user station having one or more open accounts, the server 142 can give it access to all the SMUBs, subject to certain conditions that will be described below.

An SMUB may be defined by its creator as being public. In this case, any third-party station 300 can proceed to call up SMUBs, from its browser 312, by means of the function 352, which then accesses the server for public SMUBs 152, which interrogates the subassembly of SMUB data stored at 144 which corresponds to public SMUBs.

Tables 1 to 4 of Annexe A show a particular embodiment of the invention. In these tables, the data of a personal nature are imaginary and do not set out to correspond to actual data. This is the case in particular for email addresses and URLs.

Table 1 defines 3 different users or actors, distinguished by different email addresses in the column U_email. A single actor, for example a@b.com, may have three distinct usernames (also referred to as short names or aliases), for example “Jean”, “Mickey” and “Jdupont”, as indicated in the column U-shortName. At least some of these usernames may have a long name, as indicated in the column U-longName. A password for managing the account and the SMUBs is stored in the column U_PW. Finally, each line has an internal identifier in the column Int_id.

Depending on the choice of configuration of the server, it is possible:
for the password to be associated with a user account and to remain the same for the different usernames thereof,
for each username to be associated with a password belonging to it, and for there to be no password associated with the user account,
or for there to be both an “account” password associated with a user account, and, in addition, another password for each alias, with different privileges. For example, the password “alias” gives permission to manage the SMUBs associated with the alias, but not those of the other usernames. This may be convenient for example when the members of the same family share the same email address.

Looking now at Table 2: each line has an internal identifier in the column O_id. Table 2 defines the correlation between an SMUB, determined by the columns U-shortName and suffix, and an address on the extended network, or on an internal (or even external) reader of the user station, defined in the column URL, which is matched to a column of identifiers URLid. It is very advantageous to provide a column labelled U_priv for indicating the level, and/or a title column labelled Title.

It will be seen for example that, under his three different usernames in Table 1, the user having the email address a@b.com in Table 1 has a total of 6 lines of SMUBs in Table 2. The second Oid2 makes it possible to navigate to its internal hard disk (C:). The last one Oid6 makes it possible to navigate to an email address. The others are directed at locations or indirect addresses on the extended network, in this case the Internet. The skilled man will understand the remainder of the structure of Table 2, including the fact that the first number of the URL identifier URLid is specific to the username in question, U_ShortName.

As shown in Table 2, the same SMUB (“Jean/Paris”) may relate to a number of different URLs. Calling up this SMUB will thus take place by displaying the different URLs for selection, for example in the form of a list or table.

Looking now at Table 3: each line has an internal identifier in the column KW_id. The column KW contains keywords taken in this case from the title column Title in Table 2. The column Oid contains, in this case in the form of a list, the identifiers of the lines in Table 2, the title of which contains the keyword for the line. To simplify, Table 3 contains only some of the keywords in Table 2. The non-discriminating words such as “My” or “to” in “My trip to Paris” can be ignored. Moreover, some words can be interpreted, such as “Yellow pages”, converted into “Directory”.

In reciprocal fashion, conversion into “Directory” may be carried out on the presentation of “Yellow Pages” as a multi-term keyword (if a multi-term keyword is allowed), or on the presentation of “Yellow” and “pages” as two single-term keywords (one word at a time).

The keywords are not necessarily stored in the title. They may be stored directly in Table 3, correlating with the Oid of the SMUB currently in use.

Preferably, the user will be allowed to input his own keywords, notably with regard to the title. Thus provides human indexing of the contents of the URL, which is much more accurate and reliable than an automatic indexing system, statistically at least. If the user does not spontaneously input the keyword, the system may suggest a title taken from the URL, and keywords taken from this title, which the user validates, after having changed them if he wishes.

Reference will now be made to Table 4. The columns Int_id_owner and Int_id_links denote usernames, by their identifier Int_id in Table 1. Of course, the presentation of Table 4 is only an example, and the contents of the boxes Int_id_links could be conceived as a list of values Uid.

In Table 5, the column Int_id_links has the same meaning as in Table 4 but in this case in the form of a list, and the column Oid denotes an SMUB which the user of the column Int_id_links can access. In this case:
the Oids in Table 5 have to correspond to SMUBs of level 1 (private sphere) in Table 2, and
a user appearing in the column Int_id_links in Table 5 opposite an Oid must also appear in Table 4 opposite the owner (creator) of the SMUB that corresponds to this Oid.

Reference will now be made to the flow diagram in FIG. 3. This shows the function of “opening an account”, designated 410. To do this it is convenient first of all to go to the server site as indicated by the operation 412. The server is here designated http://smub.com.

The following operation 414 comprises opening a personal account. It is currently preferred that the personal identifier should be the user's email address, according to Table 1.

The user can then set up one or more usernames, based on this personal account, as indicated for the operation 415. A username (and hence a user) can then be designated by his identifier in Table 1, for example Uid1.

The operation 416 enables the creator of a username to input the usernames of third parties who will be included in his private sphere. The setting up user must input a third-party username. The system checks their existence, then creates a line in Table 4 (for example the first line) with, as the Int_id_owner, the identifier Uid1 for the username in question of the setting up user, and in the column Int_id_links the identifier Uid4 for the third-party username. Thus, another user who has adopted the username Uid4 will be included in the private sphere of the user who has adopted the username Uid1.

This presupposes that the other user Uid4 has informed the user Uid1 of his username. This is done, in principle, by direct or indirect personal communication. However, the system may also include a mechanism for extending the private sphere, for example on the basis of the principle “a friend of a friend may become a friend”. Let us suppose that a username Uid9 (not shown in Table 1) is part of the private sphere of the username Uid4. As Uid4 is itself part of the private sphere of Uid1, Uid9 can take advantage of this to ask Uid1 to become part of their own private sphere. To do this, Uid9 may be sent the email address of Uid1 (exclusively); preferably, the request by Uid9 is recorded by the system, which undertakes to pose the question to Uid1, and to include Uid9 in the private sphere of Uid1 if the answer is in the affirmative. This known function of setting up correlations is not illustrated.

For each usemame, the setting up user can also create one or more sets of data SMUB (see Table 2). This is preferably done using the favourites of the station, as indicated in operation 417. For example, all the favourites may be down-loaded and, for one or more usernames U_ShortName, it may be proposed that the URL of the favourite be used as the URL field, an (amendable) suggestion taken from the name of the favourite be used as the Suffix field, and the (amendable) name of the favourite be used as the Title field. The identifier fields Oid and URLid are created in the usual way, by automatic incrementation, for example.

Before the end 420, optionally, the operation 418 comprises duplicating the remote SMUB data which are present on the server to the local station.

FIG. 4 shows the function of use of an SMUB. The situation in FIG. 2 is adopted, in which there is local replication of the SMUB data.

In operation 452, the function 242 interrogates the local SMUB memory 244, and the latter gives back a target indirect network address (or URL), if the conditions of the SMUB are verified. If this is the case, the target URL is given back to the browser by the operation 454, and is terminated at 460. If there are several URLs for the same SMUB (see “Jean/Paris” in Table 2), the user is offered a choice.

If operation 452 has failed, the remote site 456 is then called up, with a request relating to the desired SMUB. (In principle, this is an SMUB created by another user.) Here again, at 458, a target URL may be received, in which case the process continues at 454 as before. Otherwise, a suitable error processing takes place at 462.

FIG. 5 is the flow diagram of the creation/modification of an SMUB. The input operation 510 reminds the user that an SMUB is to be created/modified. Then, the operation 512 consists in going on to the server site, conveniently designated http://smub.com.

The operation 514 consists of connecting to the personal account on the site, if this has not already been done. Then, the operation 520 allows a choice of one of the usernames of the personal account to which the user is connected.

The test 530 provides a choice between creating a new SMUB or modifying an existing SMUB.

If a new SMUB is to be created, the operation 532 consists in the designation of a true URL by the user, i.e. an extended indirect address that exists (or is presumed to exist) on the extended network, or an address on his workstation.

By contrast, in this case, the modification of an SMUB will only allow him to modify his URL in operation 533, and/or his suffix in operation 536 described below.

Otherwise, and in a particular embodiment, the structure of the SMUB created corresponds to a predetermined format which comprises two words, generally referred to as <word1> and <word2>, respectively, with a predefined separator (in this case “/”) between the two words. This format can therefore be written as:
<word1>/<word2>.

A username is generically referred to as <U_username>. An address call is valid if it takes the form
<U_username>/<word2>

Later on in the diagram of FIG. 5, an operation 534 is preferably provided, by which the system proposes, for <word2>, a default suffix for completing the username that forms the first part of the SMUB, and verifying the condition of uniqueness of the SMUB.

At 536, the user can decide to adjust the suffix, in which case the test 538 verifies that the combination of <U_usemame> and <suffix> is unique. If it is not, the adjustment of the suffix is continued at 539 until the condition of uniqueness is met.

The SMUB in itself is then completely defined.

Some other optional operations are then provided (individually):
Operation 540, which makes it possible to define a title for the combination of username+suffix forming the SMUB,
the operation 545 makes it possible to define descriptive keywords associated with the real URL to which the SMUB relates, or with the idea that the user has,
the operation 550 makes it possible to define a level. In the embodiment described three levels are provided: personal, private and public.

Next, the operation 555 consists in constructing the URL SMUB=<username>/<suffix>, so that it is directly accessible on the site by an interrogation sentence which might be of the type:
http://SMUB.com/<U_username>/<suffix>

According to an interesting alternative feature, one or more additional functions are added to the natural functions of the browser. One example of an additional function is the setting up of an SMUB from a URL currently in use in the browser. This function is activated (or visible) for example in the form of a push-button on the screen, if the user is already connected to his personal account on the SMUB site, with one of the usernames of this personal account. In this case, in relation to FIG. 5, the operation of the push-button enables one to jump directly to the operation 534 of defining the SMUB. Other functions or alternative forms might be envisaged, such as writing the URL currently in use on the browser as an SMUB on one or more usernames of the account in use, after selecting from a list of usernames.

In brief, in the example described, the generic format of an SMUB is:
<word1>/<word2>

Generically <U_username> is used to designate an existing username and <suffix> denotes an existing suffix for this username. An address call is valid if it takes the form
<U_username>/<suffix>

where <U_username> is contained in the columns U_ShortName in tables 1 and 2, and <suffix> is contained in the column Suffix in Table 2 opposite <U_username> in the column U_ShortName.

Thus, the address call by SMUB is accepted after a first condition has been verified, which involves at least one of the following sub-conditions:
a. compliance with the naming rule, in this case the form <word1>/<word2>,
b. the fact that <word1> is a registered usemame <U_usemame>, appearing in the column U_ShortName in Table 1 and/or Table 2, and
c. the fact that <word2> is a <suffix> appearing in the column Suffix opposite <U_username> in the column U_ShortName in Table 2.

The first condition may stop there, for SMUBs classed as public (in this example, level 0 in Table 3). It is more strict for the other levels, as one or more additional sub-conditions linked to the level are added. For example, the fact that the user calling up the SMUB has opened up a “SMUB session” on the server, identifying him, may be used. In this case:
in the example described, a private SMUB (level 1) is accessible only if the username calling it up has a Uid which appears in Table 4 opposite the Uid of the creator of the SMUB, and if, in Table 5, the Uid of this same caller appears opposite the Oid of the SMUB in question.
a personal SMUB (level 2) is accessible only if the caller is the person who created the SMUB. The operation depends in this case on the method of using passwords in Table 1. If there is only a single password for a given user, whatever his username, then the personal SMUB is accessible to the user, whatever his username. If, on the other hand, there is a different password for each username of the same user, and this username password is required on opening the “SMUB session”, it may be specified that a personal SMUB is accessible only to a single username of the user.

It will be noted that the opening of a session is not necessary when calling up an SMUB 242 in local mode, as the user is generally known to the operating system of the local station.

Reference will now be made to FIG. 6, which illustrates by means of an example the possibilities open to a user accessing the server http://SMUB.com.

On accessing the server 600, the incoming user can open a session at 602, if he has an account. If no session is opened (604), the incoming user has only restricted access to the public SMUBs (database 152 in FIG. 2). If a session is open (608), the incoming user potentially has access to all the SMUBs (database 142 in FIG. 2), subject to the conditions that apply to private and personal SMUBs.

Next, a screen is displayed showing three options:
at 612, the option of directly designating an SMUB, as a request in the database in question,
at 622, the option of running a search using keywords, in the database in question,
at 642, the option of running a search by usemame (for example), in the database in question.

In practice, the opening of the session may be included as an option in the screen defined above, the default mode (without an open session) being access only to the public SMUBs. Other functions may also be included in this screen, notably the functions described previously, such as the opening of an account, and/or the managing of the SMUBs of an account that is already open, or request or search functions other than those already described.

Reference is now made to FIG. 7 which shows the flow diagram of the direct use 612 of an SMUB. The operation 614 consists in verifying the form of the SMUB, for cutting it in order to interrogate Table 2 correctly. This verification of form may be directly associated with the input zone of the SMUB in the request 612 in FIG. 6.

Then at 616 a search is carried out in Table 2 to determine whether the pairing of <word1>, <word2> with a correlated URL exists. If it does, the target URL thus found is returned in operation 664. If not, this is a failure 618, following which the input screen in FIG. 6 may be offered again, for example. It should be noted here that the operation 614 is not absolutely essential as an incorrect SMUB request will basically be interpreted as a failure.

In FIG. 6, the call 600 may be accompanied by an SMUB as parameter, in which case the process passes directly on to the corresponding request in FIG. 7.

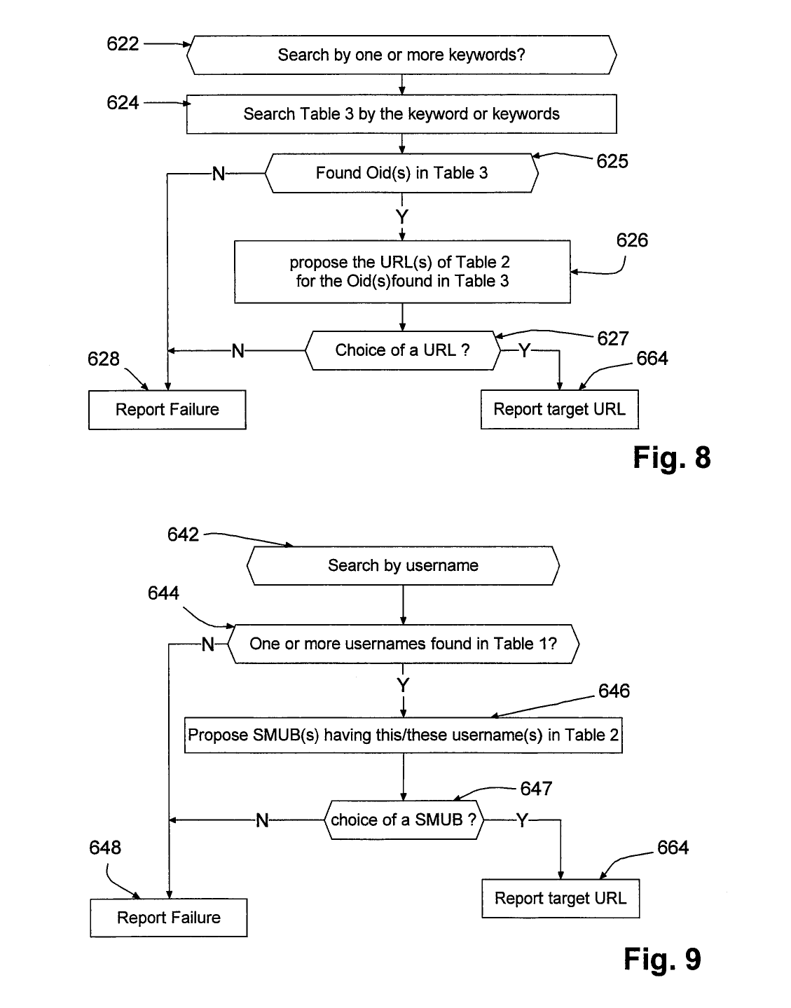

Reference will now be made to FIG. 8 which illustrates the flow diagram of the keyword search 622.

The operation 624 searches Table 3 for the keyword or keywords selected by the user. For example the single keyword “Paris” gives the list “Oid1, Oid2, Oid3” in Table 3. However, if one takes the two keywords “Paris” and “hotel”, (for example with a separator, or a multiple input zone), the only hit, by cross-referencing, will be “Oid1”.

It will be realised that at 625 one or more SMUB identifiers (“Oid”) are found in Table 3. Thus, the operation 626 will search Table 2 for the URL or URLs corresponding to this “Oid” or these “Oids”, and gives the choice of this or these URLs to the user. This may be done using a table, each line of which shows the URL found. The table may contain one or more additional columns, to provide additional information, such as the keywords corresponding to the Oid of the URL in the line, or the SMUB and/or the title corresponding to this Oid in Table 2, or the long name corresponding to the username part of the SMUB in Table 1.

If, at 627, the user accepts one of the proposed URLs, the target URL selected is returned to the operation 664.

If the user declines at 627, this is a failure 628. Similarly a failure is noted (if necessary with a suitable message) if nothing has been found in the operation 625. In the event of a failure, the input screen in FIG. 6 may be offered again, as before.

Reference will now be made to FIG. 9, which shows the flow diagram of the username search 642.

The operation 644 searches to see whether there are one or more usernames that meet the search condition (for example the start of the username) in Table 1. If there are, the operation 646 proposes the SMUB or SMUBs already defined which correspond to this/these username(s) in Table 2. If, at 647, the user accepts the proposed SMUB (one of the proposed SMUBs if there are a number of them), the corresponding target URL is returned to the operation 664. If there are a number of SMUBs proposed, they may be shown in a table, with one or more additional columns to provide additional information, for example, if there is one, the long name corresponding to each username in Table 1.

The same type of search may be carried out on other elements contained in the tables, for example the long name. In this case the operation 644 searches to see whether there are one or more usernames that meet a search condition relating to an element, for example a fragment, of a long name of a user. In this respect, it should be noted in Table 1 that the long name “Jean Dupont” gives access to the username “Jean”, which may (optionally) give access to the username “Mickey”, although the latter is not associated with the long name “Jean Dupont”. It may be decided by design to propose only the usernames that are actually associated with the long name, or, on the contrary, to suggest all the usernames, whether or not they are associated with the long name being searched (the latter option may be reserved for users submitting a request who have access to the private sphere of the user having the long name).

If the user refuses at 647, this is a failure 648. Similarly a failure is noted (if necessary with a suitable message) if nothing has been found in the operation 644. In the event of a failure, the input screen in FIG. 6 may be offered again, as before.

As the skilled man will realise, the screen defined in connection with FIG. 6 may be designed as an event form, which has three input zones for the operations 612, 622 and 642, respectively, and possibly other zones or buttons for the other functions mentioned. The user fills in the zones for which he intends to search an SMUB, and this inputting triggers the corresponding operation. However, if an SMUB arrives at the beginning as a parameter, the search can be launched directly at 612.

Of course, it is also possible to cross-reference the search terms, for example to cross-reference a username search with a keyword search.

The invention is not limited to the embodiments described above but also includes all the variants contained within the scope of the claims hereinafter, particularly the following:
a. the generic format of an SMUB being of the <word1>/<word2> type or similar, it is also possible to add constraints on the length of <word1> and/or <word2>;
b. it would be possible to do without the separator (the oblique stroke) in some cases, for example if <word1> is of a fixed length, or if <word2> begins with a capital letter, the remainder being in lower case.
c. The examples of tables given are by way of illustration; it is possible to cut at least some of the tables, for example by separately storing the URLs associated with their identifier URL_id. It is also possible to combine them at least partially, even if it means creating a certain redundancy.
d. The condition of uniqueness of the SMUBs is not absolutely essential. It would be possible to have duplicates, provided that they are pointed out, and/or provided that the creator of the duplicates can remove the ambiguity.
e. The user station may comprise a function of use of the command input bar of software installed in said station.
f. The user station may comprise a link with a voice command.

Particular rules may be defined. For example, it may be stipulated that <word2> is necessary a string a characters that does not contain the predefined separator (“/”), or even that contains only letters and numbers, whereas <word1> may be a string of characters of any kind, which may even include the predefined separator (in this case the oblique stroke “/”). In this case, a distinction can be drawn between <word1> and <word2>, and they can be separated from each other by searching for “/” starting from the right in the complete string of characters of the SMUB which is of the form <word1>/<word2>.

This may in particular make it easier to create usernames for the large number of potential users with the first name “Jean”, by incorporating part of their surname in the username. Thus, for example, a distinction can be drawn between the usernames “Dup/jean” and “Pla/jean”.

The examples given for the “first condition”, its sub-conditions and the additional conditions linked to the levels are given as an illustration without being restrictive. Naturally, it would also be possible to design equivalent conditions differently, and eliminate any redundancies.

Similarly, the number of levels and the sub-conditions associated with each of the levels (other than “public”) are not restrictive. In some cases at least, it would be possible to define the private sphere (at least partly) not by those that are included in it but by those that are excluded from it. The same remark applies to SMUBs in the private sphere.

In the foregoing description, a “username” is assumed to be non-amendable. It can only be deleted, if necessary. One alternative would be to allow the amendment of a username. This would involve either amending all the SMUBs that stem from the amended username as a result (if necessary temporarily saving the SMUBs composed with the old username), or deleting all the SMUBs that stem from the usemame, thus making it necessary to recreate them as required.

Moreover, other embodiments of processes according to the invention may be derived from the foregoing description, notably in association with the drawings.

Obviously, some of the means described hereinbefore may be omitted from the embodiments in which they are not needed.

1-20. (canceled)

21. Indirect network address server, comprising:
a store of correlations between address calls and network addresses, and
an address providing service designed to respond to the submission of an address call by giving back the network address corresponding to it, characterized in that it comprises a user account manager,
wherein the storage of correlations between address calls and network addresses comprises address calls stored as multiplets of a predetermined format, this format comprising an element linked to a user provided with an account according to a predetermined naming rule, whilst the network addresses are indirect addresses, and
wherein the address providing service is designed to respond to an address call in the form of a multiplet having the predetermined format by giving back the indirect network address that corresponds to this multiplet, subject to a first condition being met, which associates the link with a user according to said predetermined naming rule.

22. The server of claim 1, wherein the storage of an address call further comprises a level indicator, defined by the user, and in that said first condition also involves the level indicator.

23. The server of claim 1, wherein the user account manager is arranged so that each user account is associated with at least one usemame, and in that the naming rule comprises the insertion of a username in a predefined position in said predetermined format.

24. The server of claim 23, wherein the predetermined format comprises the username, followed by a separator, then a suffix.

25. The server of claim 23, further comprising a tool for opening the user session, and wherein the first condition also involves the fact that the address call comes from a user who has an open session with enablement at the level wanted for this address call.

26. The server of claim 23, wherein the storage of an address call also comprises a heading, defined by the user, wherein the server also comprises a tool for searching by keywords taken from the headings, capable of aiming at one or more address calls for which the heading contains one or more keyword submitted, subject to the first condition being met, and in that the address providing service is also designed to allow a keyword search, in order to obtain an indirect address over the extended network.

27. The server of claim 23, wherein:
the user accounts manager comprises a first table containing, for each line, a user identifier, a username, and an item of checking data, and
said store of correlations comprises a second table containing, for each line, a username, a representation of the address of a connection on the extended network, and a level indicator.

28. The server of claim 27, wherein the address providing service is also arranged so as to allow searching by username, in order to obtain an indirect address on the extended network.

29. A user IT station, comprising:
a browser, wherein the browser comprises a mechanism capable of establishing a connection with an indirect network address server,
wherein the connection including a parameter that comprises an address call in the form of a multiplet of a predetermined format, and, on confirmed return, of activating the browser with at least some of the return data as network address.

30. The station of claim 29, further comprising a local replication of the address providing service, for multiplets corresponding to a user of the station, this local replication interrogating the address server for multiplets that do not correspond to a current user of the station.

31. A method for assisting data browsing, wherein a server is provided, that has a store of correlation between address calls and network addresses, and an address providing service designed to respond to the submission of an address call by giving back a network address corresponding to it, this server being interrogated in order to reach a network location, comprising:
maintaining a user account manager on the server;
storing in a store on the server, correlations between address calls and indirect network addresses, comprising address calls stored as multiplets of a predetermined format, this format comprising an element linked to a user according to a predetermined naming rule;
designing an address providing service to respond to an address call in the form of a multiplet having the predetermined format by giving the extended network address corresponding to this multiplet, subject to a first condition being met, which associates the link with a user according to said predetermined naming rule, and
providing at least one user station with a mechanism capable of establishing a connection with said server, the connection allowing an address call in the form of a multiplet of a predetermined format, and, once return has been confirmed, activating the browser with the return data as an indirect network address.

32. The method of claim 31, further comprising providing at least one user station with a mechanism for access to an account, capable of interacting with the user account manager.

33. The method of claim 32, further comprising providing at least one user station with a replication of the address providing service.

34. The method of claim 31, wherein the store comprises, for each correlation, a level indicator; and wherein designing the address providing service takes account of the level indicator.

35. The method of claim 31, wherein the user account manager is designed so that each user account is associated with at least one usemame, and in that the naming rule comprises inserting a user alias in a predefined position in said predetermined format.

36. The method of claim 35, wherein the predetermined format comprises the username, followed by a separator, then a suffix.

37. The method of claim 31, wherein designing the address providing service comprises an offer to open a user session, and in that said first condition also uses the fact that the address call comes from a user who has an open session with enablement at the desired level for this address call.

38. The method of claim 31, wherein the storage of an address call also comprises storage of a heading, defined by the user, designing the address providing service comprises an offer to search by keywords taken from the headings, capable of aiming at one or more address calls the heading of which contains the keyword or keywords submitted, subject to the first condition being met, in order to obtain at least one indirect address over the extended network.

39. The method of claim 31, wherein the user accounts manager comprises a first table containing, for each line, a user identifier, a username, and an item of checking data, and said store of correlations comprises a second table containing, for each line, a username, a representation of the address of a connection on the extended network, and a level indicator.

40. The method of claim 39, wherein designing the address providing service allows searching by username, in order to access one or more multiplets, making it possible to obtain at least one indirect address on the extended network.
